(19) United States
(12) Patent Application Publication
(10) Pub. No.: US 2020/0287431 A1
(43) Pub. Date: Sep. 10, 2020

(54) ELECTRIC MACHINE WITH ELEVATED POWER DENSITY

(71) Applicant: Compact Dynamics GmbH, Starnberg (DE)

(72) Inventors: Richard Bernauer, Weilheim (DE); Stefan Riess, Kaufering (DE)

(21) Appl. No.: 16/759,036

(22) PCT Filed: Oct. 22, 2018
(86) PCT No.: PCT/EP2018/078888

§ 371 Date: Apr. 24, 2020

(30) Foreign Application Priority Data
Oct. 26, 2017 (DE) 10 2017 010 109.4

(51) Int. Cl. H02K 1/27

(52) U.S. Cl. CPC H02K 1/2706

(57) ABSTRACT

The invention relates to an electric machine comprising either a circular-ring-cylindrical stator and a circular-cylindrical rotor which is arranged rotatably inside the stator, or a circular-cylindrical stator and a circular-ring-cylindrical rotor, which is arranged rotatably outside the stator, there being an air gap formed between the stator and the rotor. The rotor comprises a magnetically conductive rotor body and at least one pair of magnets arranged adjacently within the rotor body, wherein magnet axes leaving identical poles of the magnets of the magnet pair intersect one another on the side of the magnets of the magnet pair facing the stator. The rotor body has at least one recess in a region extending in the circumferential direction and radial direction of the rotor and defined by the magnet pair.

An electric machine with increased power density is described herein. In particular, an electric machine having a rotor body with a particularly energy-efficient design is described.

### TECHNICAL BACKGROUND

An electric machine is understood herein to mean an electric machine in the form of an internal or external rotor machine. An electric machine may be an electric motor as well as an electric generator. Electric machines that are multi-permanently excited up to several hundred kilowatts or electric machines operated by electrically excited magnet poles are used nowadays in the drive train in avionic or automotive applications. In addition, such electric machines may be equipped with a distributed winding, for example a wave winding. Machines of this type can achieve high power densities due to the advantageous effect of the winding concept on losses that occur.

High torques and high rotational speeds of the rotor of the electric machine may be achieved as a result of the high power density. The power density and the achievable torque may be further optimized by means of a particularly small gap between the rotor and the stator.

Although such an arrangement of the rotor and the stator may attain high torques and thus a high EMF, the high EMF works against the achievable rotational speed of the rotor.

### Underlying Problem

The object, therefore, is to provide an electric machine that can achieve high rotational speeds and high torques and is still cost-effective to manufacture. Such an electric machine is advantageous in particular for mass production in the avionic or automotive field for electromobility applications.

### Proposed Solution

To achieve the object, an electric machine is proposed that comprises either a circular ring cylindrical stator and a circular cylindrical rotor that is rotatably situated inside the stator (internal rotor), or a circular cylindrical stator and a circular ring cylindrical rotor that is rotatably situated outside the stator (external rotor). An air gap is formed between the stator and the rotor to ensure unhindered rotation of the rotor. In both cases, the rotor comprises a magnetically conductive rotor body and at least one pair of magnets adjacently situated within the rotor body. Magnet axes exiting identical poles (the respective north pole or south pole) of the magnets of the magnet pair intersect on the side of the magnets of the magnet pair facing the stator. The rotor body may have at least one recess in an area defined by the magnet pair, for example an area delimited by the magnet pair, extending in the circumferential direction and radial direction of the rotor.

In the present description, a rotational axis direction of the rotor body extends on or parallel to a rotational axis about which the rotor rotates. Correspondingly, the radial direction extends perpendicularly to this rotational axis. The radial direction also extends parallel to a section plane through the electric machine, with the rotational axis perpendicular to the section plane. The circumferential direction in turn extends within such a section plane, about the rotational axis with a certain arbitrary radius.

A magnetically conductive rotor body is understood to mean a rotor body made of a material that on the one hand transmits, i.e., does not block or significantly alter, the magnetic field of the magnets of the magnet pair, but on the other hand also has an inductive effect on other electrical conductors during the movement of the rotor. These materials include, for example, iron-containing materials such as cobalt-containing or nickel-containing metals. Thus, for example, the rotor may be made up of a plurality of metal sheets situated in abutment with one another in the rotational axis direction.

The magnet axes of the magnets are any given axes, defined in each case within a magnet, that directly join the two poles of the magnets. In other words, a magnet axis of a magnet extends along the shortest magnetic field line in the center of the magnet from one pole to the opposite pole, for example from the south pole to the north pole. The magnets of a magnet pair, whose magnet axes intersect on the side facing the stator, are thus situated in the rotor body in such a way that given poles of the magnets in each case, for example the north poles of the two magnets, are opposite one another in a manner of speaking, but the magnet axes of the two magnets are not superposed or in parallel to one another, viewed in a section plane of the rotor body and of the magnets. Rather, the magnets are situated in the rotor body (in the section plane) in such a way that their magnet axes, for example exiting from the north pole in each case, intersect at an angle greater than 180°, and their intersection point, with respect to a direct connecting line of the centers of the magnets, is situated on the side of the connecting line facing the stator.

If a virtual axis, which separates the two poles of a magnet and is thus perpendicular to the magnet axis of the magnet, is viewed in a section plane of the rotor body, the virtual axes of both magnets of a magnet pair form a V-shaped configuration of the magnets of the magnet pair. The opening in the “V” faces the stator. The poles of the magnets of the magnet pair that face the inside of the “V” have the same polarity.

The adjacently situated magnets may have any given cross section in a section plane of the rotor. For example, rectangular, circular, elliptical, etc., magnets may be situated in the rotor body.

The adjacently situated magnets are provided in the rotor body in such a way that no additional magnet is situated between the magnets in the circumferential direction. Rather, the area between the two magnets in the circumferential direction is made of the material of the rotor body and/or of a fluid that is present in a recess. Alternatively, the magnet pair may be formed from two groups of magnets, in which the magnet axes of the magnets of a group of magnets are parallel to one another or coincide with one another, and oppositely situated poles of adjacently situated magnets of a group of magnets point toward one another. The area between the magnets of a group of magnets may be made of the material of the rotor body and/or of a fluid that is present in a recess.

The area which is defined or delimited by the magnet pair (or two groups of magnets) and which extends in the circumferential direction and radial direction of the rotor includes this area of the rotor body, situated between the (innermost) magnets of the magnet pair, up to the surface of the rotor body that faces the stator. The area is delimited by the magnets of the magnet pair into the interior of the rotor body. The delimitations of the area in the circumferential direction may be defined by any given axis that extends on or through the particular magnet. For example, an axis that runs on the particular magnet may extend on a side facing away from the stator, but also on a side of the particular magnet facing the stator. In addition, the axis may separate the two poles of the particular magnet and be perpendicular to the magnet axis, and may be elongated in both directions, thus determining the area of the rotor body that is defined or delimited by the magnet pair.

Due to the mutually facing poles of the magnets of the magnet pair, the area defined by the magnet pair becomes the pole-forming area of the rotor (also referred to as the pole region). The pole-forming area defined by the magnet pair is situated in the section plane of the rotor body, but also extends, corresponding to the extension of the magnets, in the rotational axis direction, parallel to the rotational axis of the rotor.

At least one recess is provided in this area (pole region) that is defined or delimited by the magnet pair, thus increasing the power density of the electric machine. In the present context, power density is understood to mean the quotient of the power (in kW) to the mass (in kg) of the electric machine, but may also be defined by power divided by mass of the stator/rotor arrangement.

Due to the at least one recess in the area defined by the magnet pair, the rotor in this area does not form a complete circular segment (for an internal rotor) or a circular ring segment (for an external rotor). Viewed in a section plane, the areas in which the magnets are situated (also referred to as magnet pockets) and the at least one recess form openings with respect to a complete circular segment or a complete circular ring segment. Mass may thus be saved, as the result of which the rotor is more lightweight and the power density is increased.

For example, the rotor may be made up of a plurality of metal sheets situated in abutment with one another in the rotational axis direction. These metal sheets are each situated in a section plane of the rotor. The at least one recess may be produced during manufacture of the metal sheets, for example by stamping or cutting whole sheets. The at least one recess may have the same design in each of the metal sheets, so that the recesses have the same shape in the rotational axis direction. Alternatively, the shape of at least one of the recesses may change in the rotational axis direction, including an end and a (new) beginning of a recess.

In one embodiment, one of the at least one recess may be situated on a side of the rotor body facing the stator (i.e., situated on its surface). Such a recess may extend in the circumferential direction of the rotor, so that a radius of a surface that delimits the rotor body and faces the stator changes in the circumferential direction of the rotor. Of course, the recess may also extend in the rotational axis direction of the rotor, for example with the same extension as the extension of the magnets of the magnet pair in the rotational axis direction.

Typical electric machines have a rotor with an ideally circular design at the outer diameter of the internal rotor or at the inner diameter of the external rotor. In a departure therefrom, the embodiment of an electric machine described herein has a rotor whose radius at the surface facing the stator has a varying size, depending on the angular position (i.e., depending on the position in the circumferential direction). The sectional area of the rotor (lying in a section plane) is thus approximately delimited by a polygon. The resulting air gap with respect to the stator, between the magnets of the magnet pair, i.e., at the edge of the area defined by the magnet pair, is thus slightly larger than in sections between the areas defined by the magnet pair. Such a recess, situated on a surface of the rotor body in the rotor section plane, reduces the inductive effect of the rotor body on the stator windings due to the greater distance of the rotor body material from the stator windings. Likewise, such a recess allows the electric machine to operate at higher rotational speeds of the rotor while maintaining the EMF. In addition, the torque is not appreciably reduced when operated in motor mode. The latter has been demonstrated, for example, in the drag mode of the rotor. This is due in particular to the fact that a reduction in the direct magnetic flux is achieved (in the radial direction between the rotor and the stator), and at the same time, the magnetic flux is maintained in the transverse direction (in the circumferential direction between the rotor and the stator).

The recess situated on the side of the rotor body facing the stator may have at least one section that extends linearly in the circumferential direction of the rotor. The recess may have a design, for example, that is triangular, quadrangular, or in the shape of some other type of polygon, in the section plane of the rotor. In other words, the at least one recess forms a section that crops a complete circular segment or a complete circular ring segment. Thus, the rotor on its side (surface) facing the stator may be polygonally cut away with respect to an ideal circular surface (in the case of an internal rotor, toward the rotational axis, and in the case of an external rotor, away from the rotational axis).

Alternatively or additionally, the recess situated on the side of the rotor body facing the stator may have at least one section that extends in a curve in the circumferential direction of the rotor. The curvature of the at least one curved section may likewise be positive in comparison to the ideally circular side of the rotor facing the stator. In the case of an internal rotor, the surface progression of the body is continuously convex in a section plane, whereas in the case of an external rotor it is continuously concave. Of course, at least one of the at least one curved section may have a negative curvature, so that in the case of an internal rotor it forms a concave side of the rotor facing the stator, and in the case of an external rotor forms a convex side of the rotor facing the stator.

In another embodiment, the recess situated on the side of the rotor body facing the stator may have a symmetrical design in the area of the rotor body defined by the magnet pair, in the circumferential direction of the rotor. In other words, the radius of the surface of the rotor, depending on the angular position, always has two locations with the same value that are situated symmetrically on two sides of a given axis of symmetry extending in the radial direction. Alternatively, the recess situated on the side of the rotor body facing the stator may have an asymmetrical design in the circumferential direction of the rotor, in the area of the rotor body defined by the magnet pair. In other words, there is no shared axis of symmetry of the radii of the rotor in the radial direction.

Alternatively or additionally, the recess situated on the side of the rotor body facing the stator may be situated symmetrically with respect to the magnet pair in the circumferential direction of the rotor, in the area of the rotor body defined by the magnet pair. An axis of symmetry of the recess may coincide with an axis of symmetry that is defined by the magnets of the magnet pair. Alternatively, a recess having a symmetrical design may be asymmetrically situated. In this case, a recess that is symmetrical in the circumferential direction may be situated closer to one magnet of the magnet pair than to the other magnet of the magnet pair.

Likewise, a recess that is asymmetrical in the circumferential direction may be situated symmetrically with respect to the magnets of the magnet pair. For example, a start and an end of the recess in the circumferential direction may be situated symmetrically with respect to an axis of symmetry of the magnets of the magnet pair. The start and the end of the recess are the two locations of the side of the rotor facing the stator at which the radius of the rotor surface deviates from an ideal circular surface. In contrast, the course of the radii between the start and the end of the recess is not symmetrical in the circumferential direction.

In one variant of the rotor, the recess situated on the side of the rotor body facing the stator extends in the circumferential direction of the rotor over 25% to essentially 100% of the area defined or delimited by the magnet pair. In other words, over 25% to essentially 100% of the area defined by the magnet pair, the radius of the rotor surface in the circumferential direction deviates from an ideal circular surface progression of the rotor in a section plane. The recess should not attain exactly 100% of the area defined by the magnet pair, since otherwise the air gap with respect to the stator would be enlarged over the entire area, thus reducing the torque to be achieved by the electric machine. In addition, the recess situated on the side of the rotor body facing the stator may preferably extend in the circumferential direction of the rotor over 50% to 85% of the area defined by the magnet pair, and particularly preferably extends over 75% of the area defined by the magnet pair.

In one particular embodiment, the recess situated on the side of the rotor body facing the stator forms a surface progression of the rotor that is positively curved in a section plane, that is, a continuously convex surface for an internal rotor and a continuously concave surface for an external rotor. For example, the air gap between the stator and the rotor is enlarged by 62% in the radial direction due to the recess. Thus, the thickness of the air gap may be increased from 0.8 mm in the border area of the pole-forming area (toward an adjacent area that is defined by a further magnet pair) to 1.3 mm in an area of the greatest change in the radius of the rotor surface (for example, in the center, situated in the circumferential direction, of the area defined by the magnet pair). The EMF may thus be reduced by approximately 11%, while the torque generated by the electric machine is practically unchanged. The border area of the area defined by the magnet pair may be in the circumferential direction of the area of the rotor, in which a cross inductance L_{q} is present and a predominant portion of the torque of the electric machine is formed. In the area in between, in particular in the center of the area defined by the magnet pair, viewed in the circumferential direction, a direct inductance L_{d} may be present, where little or no torque is formed.

Regardless of these embodiments of the electric machine, the air friction losses due to the varying air gap are very low. An increased rotational speed is not adversely affected by air friction losses.

In another embodiment, the at least one recess may be situated on a side of at least one of the magnets of the magnet pair facing away from the stator. Due to the V-shaped configuration of the two magnets of a magnet pair, the side of a magnet facing away from the stator is the side of the magnet which for an internal rotor is closer to the rotational axis of the rotor, and which for an external rotor is farther from the rotational axis, and also faces a corresponding side of the further magnets of the magnet pair. The at least one recess may represent an extension and/or expansion of a magnet pocket containing the magnet; air or some other magnetically nonconductive fluid, not magnetic material, is contained in the recess.

The at least one recess configured in this way allows an increase in the power density solely due to the saving of rotor body material and the accompanying reduction in weight. In addition, the leakage flux between homopolar magnets is reduced or entirely avoided due to the interruption of the rotor material. The magnetic field formed by the magnets thus closes more distinctly from the north pole to the south pole, thereby likewise increasing the power density. Another effect of the at least one recess is the reduction in mechanical stresses on the rotor that result from centrifugal forces. Due to the at least one recess on a side of at least one of the magnets of the magnet pair facing away from the stator, mechanical stresses in the rotor induced by centrifugal forces may be equalized, i.e., flatly set to a uniform level. At the same time, the magnetic path length between the two magnets of the magnet pair is extended around the recess, since the recess contains air or some other magnetically nonconductive material. This results in an improved magnetic flux between the magnets of the magnet pair in the direction of the stator.

In addition, the recess situated on the side of the magnet facing away from the stator may have a kidney-shaped design. The recess has a curved or circular design in the section plane of the rotor. Additionally or alternatively, the recess may extend further toward the stator in the radial direction (thus, outwardly and away from the rotational axis for an internal rotor, and inwardly and toward the rotational axis for an external rotor) than an edge of the magnet, with the edge facing the center of the area defined by the magnet pair and the side of the rotor body facing the stator. Alternatively or additionally, the recess may extend further in the radial direction with respect to the rotational axis of the rotor.

When the recess together with a magnet pocket that accommodates the magnet forms a shared cavity, the recess forms an appendage which for an internal rotor extends away from the rotational axis to an outer side of the rotor, and for an external rotor extends toward the rotational axis to an inner side of the rotor. The recess thus extends into the area of the rotor defined by the magnet pair.

In one variant, a recess may be situated in each case on opposite sides of the magnets of a magnet pair. The two recesses may be symmetrically formed in a section plane of the rotor. In the present case, an axis of symmetry of the area delimited by the magnet pair and/or of the magnet pockets may be used as the axis of symmetry. In addition, the two recesses may be spaced apart from one another in the circumferential direction, so that the rotor material in the area delimited by the magnet pair is connected to the remaining rotor material, viewed in the radial direction, via a web between the two recesses (for an internal rotor, the farther inwardly situated rotor material, and for an external rotor, the farther outwardly situated rotor material). In particular, providing two recesses increases the magnetic path length between the two magnets of the magnet pair. Two kidney-shaped recesses result in an improved magnetic flux between the magnets of the magnet pair in the direction of the stator.

In another embodiment, the recess may be situated on a side of at least one of the magnets of the magnet pair facing the stator. Due to the V-shaped configuration of the two magnets of a magnet pair, the side of a magnet facing the stator is the side that for an internal rotor is closer to the outer side of the rotor, and for an external rotor is closer to the rotational axis of the rotor, and also faces a corresponding side of a further magnet of an adjacent magnet pair. The at least one recess may represent an extension of a magnet pocket that accommodates the magnet, wherein air or some other magnetically nonconductive fluid, not magnetic material, is contained in the recess.

The recess situated on the side of a magnet facing the stator likewise increases the power density of the electric machine. The power density of the electric machine is increased solely due to the weight savings. In addition, the mechanical stresses in the rotor body material surrounding the recess, resulting from centrifugal forces, are reduced.

The recess may have any desired shape. For example, the recess in a section plane of the rotor is hook-shaped, the recess extending from the side of the magnet facing the stator or the associated magnet pocket in the circumferential direction of the rotor and/or in the radial direction.

According to one variant, the recess situated on the side of the magnet facing the stator may be connected to a corresponding recess situated on a side of a directly adjacent magnet facing the stator. The directly adjacent magnet may be a magnet of a neighboring magnet pair, wherein the adjacent magnet belongs to a neighboring further area of the rotor defined by the magnet pair in question.

Due to this connection of the recesses of two adjacent areas of the rotor that are defined by respective magnet pairs, the neighboring magnet pockets of the different areas defined by respective magnet pairs may be connected, and form a continuous opening in the rotor in a section plane of the rotor. Mechanical stresses in the rotor, which are typically created by centrifugal forces, may be further reduced by such a design of the connected recesses. The connected recesses thus form a relief cut, as the result of which stresses acting on the rotor material, in particular stresses in the radial direction of the rotor, may be significantly reduced.

In another embodiment, the magnets that form the at least one magnet pair are in each case permanent magnets. Rotors having a simple design may be manufactured using permanent magnets. Alternatively, at least one magnet in the rotor is implemented by an electromagnet. Although this requires electrification of the rotor, it allows greater variability in the use of the rotor.

For the permanently excited electric machine, in which the rotor is fitted with permanent magnets, its magnetic field (in motor mode) may interact with the magnetic field that is created by the stator energization in order to bring about rotation of the rotor. In generator mode, rotation of the rotor creates electrical power that may be tapped at the terminals of the stator winding.

Providing at least one recess in the area defined by a magnet pair results in an improvement in the mechanical properties of the rotor body during rotation. In addition, a weight reduction of the rotor is achieved, which on the one hand allows the power density of the electric machine to be increased. On the other hand, for the same or similar weight of the rotor, an overall greater amount of magnetic material may be provided in the rotor. The torque to be achieved by the electric machine may be increased in this way.

In one embodiment, the rotor has a total of eight areas that are defined or delimited by respective magnet pairs. This corresponds to a pole pitch of approximately 45°. Of course, the rotor may have more or fewer than eight areas that are defined by respective magnet pairs; for example, the rotor may be made up of four, six, or twelve such areas.

According to a further aspect, the electric machine includes a stator having electromagnetically acting teeth that are directed toward the rotor.

According to yet a further aspect, a vehicle includes an electric machine according to one of the described aspects.

### BRIEF DESCRIPTION OF THE DRAWINGS

Further aims, features, advantages, and possible applications result from the following description of exemplary embodiments, which are not to be construed as limiting, with reference to the associated drawings. All features described and/or graphically illustrated, alone or in any combination, constitute the subject matter disclosed herein, also independently of their grouping in the claims or their back-references. The dimensions and proportions of the components shown in the figures are not necessarily to scale, and in the embodiments to be implemented may differ from those illustrated herein.

In the figures:

FIG. 1 shows a schematic sectional illustration of one variant of an area of a rotor of an electric machine that is defined by a magnet pair,

FIG. 2 shows another schematic sectional illustration of a rotor detail, with one complete area and two adjoining half areas that are defined by respective magnet pairs, and

FIG. 3 shows an enlarged detail of the schematic sectional illustration shown in FIG. 2.

### DETAILED DESCRIPTION OF THE DRAWINGS

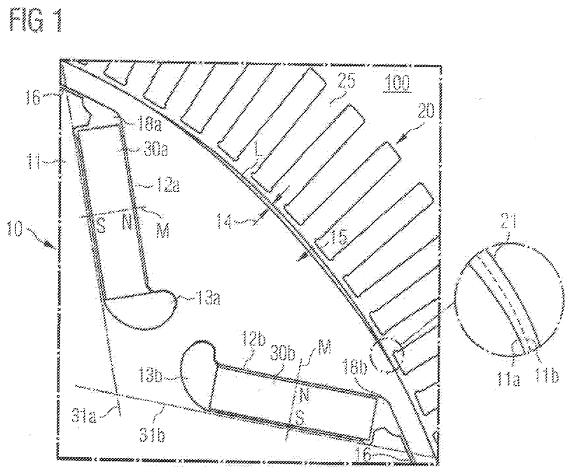

An electric machine 100 partially depicted in FIG. 1 has a rotor 10, explained in greater detail below. The electric machine 100 includes a hollow cylindrical stator 20, of which only a portion is illustrated in FIG. 1. The stator 20 has inwardly directed electromagnetically acting teeth 25. The electromagnetically acting teeth 25 of the stator 20 may be designed as a wave winding, for example with distributed winding.

The rotor 10 of the electric machine 100 is illustrated as an internal rotor, which thus rotates along an inner side of the stator 20. An air gap L between the stator 20 and the rotor 10 is preferably small in order to achieve the highest possible torque in the electric machine 100. For example, the air gap between the stator 20 and the rotor 10 may be between 0.4 mm and 1 mm in the radial direction. In one particular embodiment, the air gap is 0.8 mm in the radial direction.

The rotor 10 includes a magnetically conductive rotor body 11 that has a plurality of magnet pockets 12. One or more magnets 30a, 30b may be situated in each of the magnet pockets 12, which extend perpendicularly with respect to the plane of the drawing in FIG. 1 (i.e., in parallel to the rotational axis D of the rotor). In the case of multiple magnets 30a, 30b, these have a homopolar arrangement, for example; i.e., their poles point essentially in the same direction. Two magnet pockets 12 are illustrated in FIG. 1. A first magnet 30a is situated in a first magnet pocket 12a, while a second magnet 30b is situated in a second magnet pocket 12b. Both magnets 30a, 30b together form a magnet pair 30, and are oriented in such a way that the same poles of the magnets 30a, 30b face one another. In FIG. 1, the two magnets 30a, 30b are illustrated such that their north poles point essentially toward a side of the rotor 10 facing the stator 20 (here, in the case of an internal rotor, an outer side of the rotor 10). Of course, the magnets 30a, 30b may also be situated in the opposite pole direction.

The magnets 30a, 30b adjacently situated inside the rotor body 11 have magnet axes M that exit from identical poles N, S of the magnets 30a, 30b, and which intersect on the side of the magnets 30a, 30b of the magnet pair 30 facing the stator 20. The magnet axes M illustrated in FIG. 1 connect the respective north and south poles of the two magnets 30a, 30b. If the magnet axes M are extended so that they exit from identical poles of the magnets 30a, 30b (in the present case, the illustrated north poles), the two magnet axes M intersect on the side of the magnets 30a, 30b facing the stator 20.

In the case of the illustrated rectangular magnets 30a, 30b, the magnet pockets 12 of the rotor 10 are situated in pairs in a V shape in the circumferential direction of the rotor 10. The detail of the rotor 10 illustrated in FIG. 1 shows only one magnet pocket pair 12. The rotor 10 of the electric machine 100 may have multiple such magnet pocket pairs 12 and associated magnet pairs 30. In particular, the magnets 30a, 30b of respective adjacent magnet pocket pairs 12 have oppositely poled magnets 30a, 30b. In other words, the magnets 30a, 30b of a magnet pocket pair 12 situated next to the magnet pocket pair 12 illustrated in FIG. 1 have south poles that point toward the stator 20.

The rotor body 11 has an area 15 that is defined or delimited by the magnets 30a, 30b of the magnet pair 30. Since a magnet pole results in this area 15 due to the mutually facing magnets 30a, 30b of the magnet pair 30 with identical poles N, the area 15 is also referred to as a pole-forming area 15. The pole-forming area 15 is defined by the magnet pair 30, and extends in the circumferential direction and radial direction of the rotor 10. FIG. 1 illustrates an example of delimitation of the pole-forming area 15 as a dash-dotted line. This pole-forming area is defined (delimited) toward the rotational axis by two axes 31a, 31b that extend on the two magnets 30a, 30b, respectively, of the magnet pocket pair 12 on the side facing away from the stator 20. Of course, these delimitation axes 31a, 31b may also extend at a distance from the magnets 30a, 30b or through the magnets 30a, 30b.

The magnets 30a, 30b of the magnet pair 30, due to the identical pole direction of the two magnets 30a, 30b, together form a magnetic field that extends from the rotor body 11 and beyond the pole-forming area 15. A magnetic interaction thus occurs with the electromagnetically induced magnetic field of the stator 20, as the result of which the rotor 10 may be set in motion. For example, the electromagnetic action of the stator 20 may be controlled in such a way that the rotor 10 runs in drag mode; i.e., the magnetic field present in the pole-forming area 15 (the pole thus produced) is attracted by a leading opposite pole of the stator 20.

At least one recess is situated in the pole-forming area 15, as the result of which a weight reduction of the rotor 10 is achieved, and due to other effects the power density of the electric machine 100 is further improved.

A recess 14 may thus be situated on a side of the rotor body 11 facing the stator 20. This recess 14 extends in both the circumferential direction and the rotational axis direction of the rotor 10, so that a radius of the rotor body 11 (a radius of a surface delimiting the rotor body 11, viewed in a section plane of the rotor) varies in the circumferential direction of the rotor 10. In other words, the air gap L between the rotor 10 and the stator 20 is larger (more pronounced) in the area of the recess 14 than in the areas without a recess 14, situated in the circumferential direction of the rotor 10. As the result of enlarging the air gap, the teeth 25 of the stator 20 are less intensely excited by the typically metallic material of the rotor body 11 in the nontorque-forming area of the rotor body 11 due to the greater distance between the rotor 10 and the teeth 25 of the stator 20.

The right portion of FIG. 1 shows an enlarged illustration of the air gap. The hollow cylinder-shaped stator 20 has an inner side 21 situated opposite from an outer side 11a, 11b of the rotor 10. The dashed line represents the outer side 11b of the rotor 10, which has a constant radius and is thus situated concentrically with respect to the outer side 21 of the stator 20. The distance between these sides 21 and 11b, i.e., the air gap L, is thus always the same in the circumferential direction. The air gap widens in the area of the recess 14. This is discernible in the enlarged area in FIG. 1 via the radially inwardly deviating course of the outer side 11a of the rotor 10 in the pole-forming area 15. In other words, the air gap L, in the present case the distance between the inner side 21 of the stator 20 and the outer side 11a of the rotor 10, is larger in the enlarged illustrated area of the rotor 10, viewed in the counterclockwise direction. Similarly, in the further course of the pole-forming area 15, viewed in the circumferential direction, the distance between the sides 21 and 11a (air gap L) becomes smaller until the outer side 11a once again coincides with the concentric dashed line 11b.

The recess 14 is illustrated in FIG. 1 with a section extending in a curve. In particular, the side of the rotor 10 facing the stator 20 has a positive curvature in the area of the recess 14; i.e., the outer side of the rotor 10 illustrated here is continuously convex. In the case of an external rotor, the interior side of the rotor would be continuously concave. This provides positive aerodynamics. Of course, the curved section of the recess 14 may also have a negative curvature, so that the illustrated outer side of the rotor 10 would have a concave design in the area of the recess 14, at least in sections. In the case of an external rotor, the interior side of the rotor would be convex in sections. The recess 14 may likewise have a linearly extending section, not illustrated in FIG. 1.

In addition, the illustrated recess 14 has a symmetrical design in the circumferential direction of the rotor 10, and is symmetrically situated between the magnets 30a, 30b of the magnet pair 30. The symmetry of the recess 14 in the circumferential direction improves the smooth running of the rotor 10. For an even number of pole-forming areas 15, the smooth running of the rotor 10 may be maintained even when the recess 14 has an asymmetrical design in the circumferential direction, but has the same shape in each pole-forming area 15 in the section plane of the rotor 10. As a result, oppositely situated points on the surface of the rotor 10 have an identical radius in a section plane, thus achieving a uniform distribution of weight.

The recess 14 may also be symmetrically arranged between the magnets 30a, 30b of the magnet pair 30 in the circumferential direction of the rotor 10. As shown in FIG. 1, the “deepest” location of the recess 14 (the location with the largest air gap) is situated in the center of the pole-forming area 15, i.e., exactly between the magnets 30a and 30b. In addition, the recess 14 may extend arbitrarily in the circumferential direction. The recess 14 illustrated in FIG. 1 extends over approximately 75% of the pole-forming area 15.

A further recess 13 is situated on a side of at least one of the magnets 30a, 30b facing away from the stator. This recess 13 may, for example, adjoin a magnet pocket 12 associated with the magnets 30a, 30b. A recess 13a or 13b on the magnet pocket 12a, 12b, respectively, is illustrated in FIG. 1. These recesses 13 represent a further or alternative reduction in material of the rotor body 11. For example, the recess 13 may be kidney-shaped, wherein a section of the recess 13 is situated farther from a side of the rotor body 11, facing the stator 20, than an end of the associated magnet pocket 12. In addition, the recess 13 situated on the side of the magnets 30a, 30b facing away from the stator 20 may extend farther from a side of the rotor body 11 facing the stator 20 than an edge of the associated magnets 30a, 30b (situated in the magnet pocket 12), wherein the edge faces the center of the pole-forming area 15 and the side of the rotor body 11 facing the stator 20.

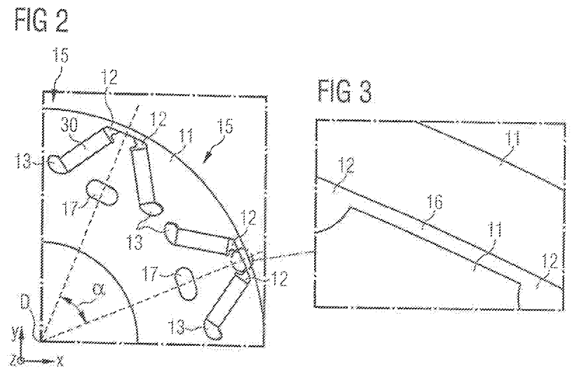

FIGS. 2 and 3 illustrate a further or alternative recess 16 in greater detail. FIG. 2 shows a detail of a rotor 10 that includes a complete pole-forming area 15 and two adjacent half pole-forming areas 15 in each case. The pole-forming area 15 may extend in the circumferential direction of the rotor 10, over a certain section of the rotor 10 that is defined by the angle α. For example, the pole-forming area 15 extends over 45° of the rotor 10, as the result of which the rotor 10 is divided into eight pole-forming areas 15.

A further or alternative recess 16 is provided on a side of at least one of the magnets 30a, 30b of the magnet pair 30 facing the stator 20. This recess 16 may be connected to a corresponding recess 16 situated on a side of a directly adjacent magnet 30a, 30b facing the stator 20. This is illustrated in an enlargement in FIG. 3. The recess 16 connects, for example, the two magnet pockets 12 of two neighboring magnets that belong to adjacent pole-forming areas 15. Alternatively, the recess 16 may also be provided without being connected to the particular magnet pocket 12, but still connected to a corresponding recess 16 in the adjacent pole-forming area 15.

A further recess 17 may be formed in an area of the rotor body 11 situated between two pole-forming areas or extending across the boundary between two pole-forming areas 15. In particular, such a recess 17 may be situated at the same height in the radial direction, between the recesses 13 or situated farther from the stator 20. For example, the recess 17 may have a centroid of the area with a radius with respect to the rotational axis D of the rotor 10 that corresponds to 80% to 120% of the radius of a centroid of an area of the recess 13 with respect to the rotational axis D. In addition, in a section plane of the rotor 10 the recess 17 may be formed symmetrically with respect to an axis that extends between two pole-forming areas 15. A recess 17 situated in this way reduces the rotor weight as well as the mechanical stresses in the rotor body 11 between two neighboring recesses 13 of two adjacent pole-forming areas 15. Due to the position between two pole-forming areas 15, no appreciable electromagnetic disadvantages occur as a result of the recess 17.

As is apparent in particular from FIG. 2, two magnet pockets 12 together with the recesses 13 and 16 may form a continuous (connected) cavity in the rotor body 11. Such a continuous cavity may be easily formed by stamping or a cutting operation in the rotor body 11, so that the rotor body 11 may be manufactured easily and cost-effectively. It should be noted that the magnets 30a, 30b situated in the two magnet pockets 12 of the continuous cavity belong to different pole-forming areas. For example, the two magnets 30a, 30b may be situated in the magnet pockets 12 of the continuous cavity with different polarities. “Different polarities” means that the north pole of one magnet 30a, 30b points to a side of the rotor 10 facing the stator 20, while the north pole of the other magnet 30a, 30b in the adjacent pole-forming area points to a side of the rotor facing away from the stator 20.

The magnet pockets 12, magnet pairs 30, and recesses 13, 14, and 16 illustrated in FIGS. 1 through 3 may of course also be correspondingly provided in an external rotor (circular ring cylindrical rotor). Here as well, the magnet axes M of the magnets 30a, 30b of a magnet pair 30 intersect on the side of the magnet pair 30 facing the stator 20, which is interiorly situated in this case. In other words, the intersection point of the magnet axes M is closer to the rotational axis D (FIG. 2) of the rotor 10 than the centers of the magnets 30a, 30b. The recesses 16 are likewise closer to the rotational axis D than the recesses 13, wherein a kidney-shaped recess 13 represents an appendage that is directed toward the rotational axis D of the rotor 10.

The variants described above as well as their design and operational aspects are used solely for better understanding of the structure, the operating principle, and the properties; they do not limit the disclosure to the exemplary embodiments, for example. The figures are sometimes schematic, and important properties and effects are sometimes illustrated in a greatly enlarged scale, in order to clarify the functions, functional principles, technical embodiments, and features. Any operating principle, any principle, any technical embodiment, and any feature that is disclosed in the figures or in the text, together with all claims, may be freely and arbitrarily combined with any feature in the text and with the other figures, other operating principles, principles, technical embodiments, and features that are contained in the present disclosure or that result therefrom, so that all conceivable combinations of the described variants are to be assigned. Also encompassed are combinations between all individual statements in the text, i.e., in any section of the description, in the claims, as well as combinations between various variants in the text, in the claims, and in the figures. Furthermore, the claims do not limit the disclosure, or thus, the combination options of all disclosed features with one another. All disclosed features are also explicitly disclosed herein, individually and in combination with all other features.

1-10. (canceled)

11. An electric machine, comprising:
a circular ring cylindrical stator and a circular cylindrical rotor that is rotatably situated inside the stator, or
a circular cylindrical stator and a circular ring cylindrical rotor that is rotatably situated outside the stator,
wherein an air gap is formed between the stator and the rotor, and wherein the rotor comprises:
a magnetically conductive rotor body; and
at least one pair of magnets adjacently situated within the rotor body, wherein magnet axes exiting identical poles of the magnets of the magnet pair intersect on the side of the magnets of the magnet pair facing the stator,
wherein the rotor body has at least one recess in an area that extends in the circumferential direction and radial direction of the rotor and is defined by the magnet pair.

12. The electric machine according to claim 11, wherein the recess is situated on a side of the rotor body facing the stator and extends in the circumferential direction and the rotational axis direction of the rotor, so that a radius of a surface delimiting the rotor body and facing the stator varies in the circumferential direction of the rotor.

13. The electric machine according to claim 12, wherein the recess situated on the side of the rotor body facing the stator has at least one section that extends in a curve in the circumferential direction of the rotor.

14. The electric machine according to claim 13, wherein in the case of the circular cylindrical rotor that is rotatably situated inside the stator, a surface progression of the rotor in the circumferential direction is continuously convex, and in the case of the circular ring cylindrical rotor that is rotatably situated outside the stator, a surface progression of the rotor in the circumferential direction is continuously concave.

15. The electric machine according to claim 12, wherein the radius of the surface delimiting the rotor body and facing the stator in the circumferential direction of the rotor is greater at the edge of the area defined by the magnet pair than in a section situated between the magnets of the magnet pair.

16. The electric machine according to claim 12, wherein the recess situated on the side of the rotor body facing the stator has a symmetrical design in the area of the rotor body defined by the magnet pair, in the circumferential direction of the rotor, and/or is situated symmetrically between the magnets of the magnet pair in the circumferential direction of the rotor.

17. The electric machine according to claim 12, wherein the recess situated on the side of the rotor body facing the stator extends in the circumferential direction of the rotor over 25% to essentially 100% of the area defined by the magnet pair, preferably extends over 50% to 85% of the area defined by the magnet pair, and particularly preferably extends over 75% of the area defined by the magnet pair.

18. The electric machine according to claim 11, wherein the recess is situated on a side of at least one of the magnets of the magnet pair facing away from the stator.

19. The electric machine according to claim 18, wherein the recess situated on the side of the magnet facing away from the stator has a curved or circular design, and/or extends farther from a surface that delimits the rotor body and faces the stator than an edge of the magnet situated at the recess, which faces the center of the area defined by the magnet pair and the surface of the rotor body facing the stator.

20. The electric machine according to claim 11, wherein the recess is situated on a side of at least one of the magnets of the magnet pair facing the stator.

21. The electric machine according to claim 20, wherein the recess situated on the side of the magnet facing the stator is connected to a corresponding recess situated on a side of a directly adjacent magnet facing the stator.

22. The electric machine according to claim 11, wherein the magnets that form the at least one magnet pair are in each case permanent magnets.
